(19) United States
(12) Patent Application Publication
(10) Pub. No.: US 2019/0232473 A1
(43) Pub. Date: Aug. 1, 2019

(54) DEVICE FOR INSERTING A TONGUE

(71) Applicant: Välinge Innovation AB, Viken (SE)

(72) Inventors: Jonas Fransson, Allerum (SE); Anders Aldsten, Hammenhög (SE)

(73) Assignee: Välinge Innovation AB, Viken (SE)

(21) Appl. No.: 16/311,224

(22) PCT Filed: Jun. 28, 2017
(86) PCT No.: PCT/SE2017/050711

§ 371 Date: Dec. 19, 2018

(30) Foreign Application Priority Data
Jun. 30, 2016 (SE) 1650955-6

(51) Int. Cl. B25B 27/02; B27M 3/00; B25B 28/00

(52) U.S. Cl. CPC B25B 27/02; B27M 3/04; B25B 28/00; B27M 3/0066

(57) ABSTRACT

A device for inserting a tongue into an insertion groove in a panel including a first part including a supporting surface configured to cooperate with an upper surface of a panel. The device includes a second part, which is connected to the first part, including a guiding device for a displaceable puncher which is configured to displace a tongue into an insertion groove of a panel. The supporting surface is extending in a first direction and the guiding device is extending in second direction.

### FIELD OF THE INVENTION

Embodiments of the present invention relate to methods and devices for inserting a tongue into an insertion groove in a panel. The panel is configured to be arranged and locked perpendicular to an adjacent panel by a locking device comprising the tongue. The panels may be assembled and locked together to obtain a furniture product, such as a bookshelf, a cupboard, a wardrobe, a box, a drawer or a furniture component.

### BACKGROUND OF THE INVENTION

A conventional furniture product may be assembled by a plurality of elements or panels. The panels may be assembled with a mechanical locking device, such as disclosed in, for example, WO 2012/154113 A1, The product comprises a first panel connected perpendicularly to a second panel by a mechanical locking device comprising, an edge tongue at the first panel, an edge groove at the second panel and a flexible tongue in an insertion groove.

WO2015038059 discloses a product assembled by a plurality of panels that are looked by mechanical locking devices comprising a flexible tongue in an insertion groove.

The locking devices of the panels are generally produced n a production line by a continuous production process, comprising a number of milling tools. The edge groove and the insertion groove may extend contiguously from a front edge to a back edge of the panel. The edge groove is preferably covered at the front edge by a decorative layer. The edge groove and the insertion groove may also end before the front edge and/or the back edge as disclosed in e.g. SE 1650135-5.

Embodiments of the present invention address a need to provide an improved device for inserting a tongue into an insertion groove in a panel.

### SUMMARY OF THE INVENTION

Accordingly embodiments of the present invention preferably seek to mitigate, alleviate or eliminate one or more deficiencies, disadvantages or issues in the art, such as above-identified, singly or in any combination by providing a device for inserting a tongue in an it groove of a panel. The device is preferably handheld or configured to be attached to an assembling table.

A further object of embodiments of the invention is to provide a device with great flexibility which is suitable for short series production.

At least some of these and other objects and advantages that will be apparent from the description have been achieved by an aspect of the invention comprising a device for inserting a tongue into an insertion groove in a panel. The device comprises a first part comprising a supporting surface configured to directly cooperate with an upper surface of a panel, such that the supporting surface is positioned relative the upper surface of the panel. The device comprises a second part, which is connected to, the first part. The second part comprise a displaceable puncher and a guiding device which is configured to guide the puncher. The puncher is configured to displace a tongue into an insertion groove of a panel.

The supporting surface may extend in a first direction and the guiding device may extend in second direction. The first direction is preferably different from the second direction.

The device may comprise a handle 50 and may be configured to be handheld.

The handle may comprise a trigger for activating a stroke of the displaceable puncher.

The device may comprise an attachment device and the device may be configured to be attached to a holding fixture or an assembling table by the attachment device.

The displaceable puncher may be displaceable in the second direction.

A first angle which is between the first direction and the second direction may be in the range of about 10° to about 90° preferably in the range of about 10° to about 45°, or is about 25°.

The device may comprise a first adjusting device for setting the first angle.

The second part may comprise a structural part and a second adjusting device for setting a position of the guiding device relative the structural part in the second direction.

The first part may comprise a positioning element for positioning the first part relative the insertion groove in the first direction. A centre of gravity of the device is preferably adjacent or at the positioning element such that the device is easy to handle and to position in the correct position. This may be an advantage particularly for a handheld embodiment of the device.

The first part may comprise a third adjusting device for setting a position of the positioning element relative the first part in the first direction.

The second part may comprise a magazine for two or more of said tongue.

The magazine may be configured for storing a second of said tongue above a first of said tongue wherein the magazine is extending essentially perpendicular to the second direction.

The second part may comprise a power unit driving the puncher during a punch for the insertion of the tongue in the insertion groove.

The groove is of an elongated shape and is extending with a length direction along the upper surface of the panel, preferably along an edge of the panel.

The tongue may be of an elongated shape and a length direction of the tongue may be parallel with the length direction of the insertion groove.

The tongue may be of an elongated shape and a length direction of the tongue may be perpendicular to a displacement direction of the displaceable puncher.

The tongue may be of an elongated shape may comprise a first tong edge and a second-long edge. The first edge may be a first short edge, and the second edge may be an opposite second short edge.

A longitudinal direction of the tongue is preferably parallel to an axis of rotation of the rotatable/rotating tool.

The tongue may be a flexible tongue and made of, e.g., a polymer and preferably comprising a reinforcement material, such as a fibre e.g. glasfiber.

The tongue may comprise a bendable part at the first long edge and preferably a groove adjacent the bendable part. The bendable part may be configured to be pushed into the groove adjacent the bendable part. The tongue may comprise several of said bendable part and preferably several of said groove.

The tongue may comprise a polymer material and is preferably produced by injection moulding.

The tongue may be connected to several tongues in the tongue blank by a first rail at the first short edge and preferably by a second rail at the second short edge.

The first rail and the second rail may extend in length direction perpendicular to the tongue.

The tongue may be connected to the first rail and/or the second rail, which may be casting gates, by a first and a second casting gate, respectively.

The tongue is preferably configured to be displaceable in the insertion groove.

The device is preferably a part of a production line comprising milling tools for forming a locking device at the edge of the panel. The locking device preferably comprises said insertion groove.

The edge groove and the insertion groove may extend contiguously front edge to a back edge of the panel.

### BRIEF DESCRIPTION OF THE DRAWINGS

These and other aspects, features and advantages of which embodiments of the invention are capable of will be apparent and elucidated from the follow description of embodiments of the present invention, reference being made to the accompanying drawings, in which

FIG. 1 shows in a 3D-view an embodiment device according to an embodiment of the invention.

FIG. 2 shows a crosscut in a side view of an embodiment of the device according to an embodiment of the invention.

FIG. 3 shows an enlargement of parts of the embodiment of the device, shown in FIG. 2 according to an embodiment of the invention.

FIG 4 shows in a side view of an embodiment of the device according to an embodiment of the invention.

FIG. 5 shows in a top view an embodiment of the device according to an embodiment of the invention.

FIGS. 6A-6D show embodiments of the tongue according to embodiments of the invention.

FIGS. 7A-7D show embodiment of the tongue according to an embodiment of the invention.

FIGS. 8A -8D show embodiments of the panel according to embodiments of the invention.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

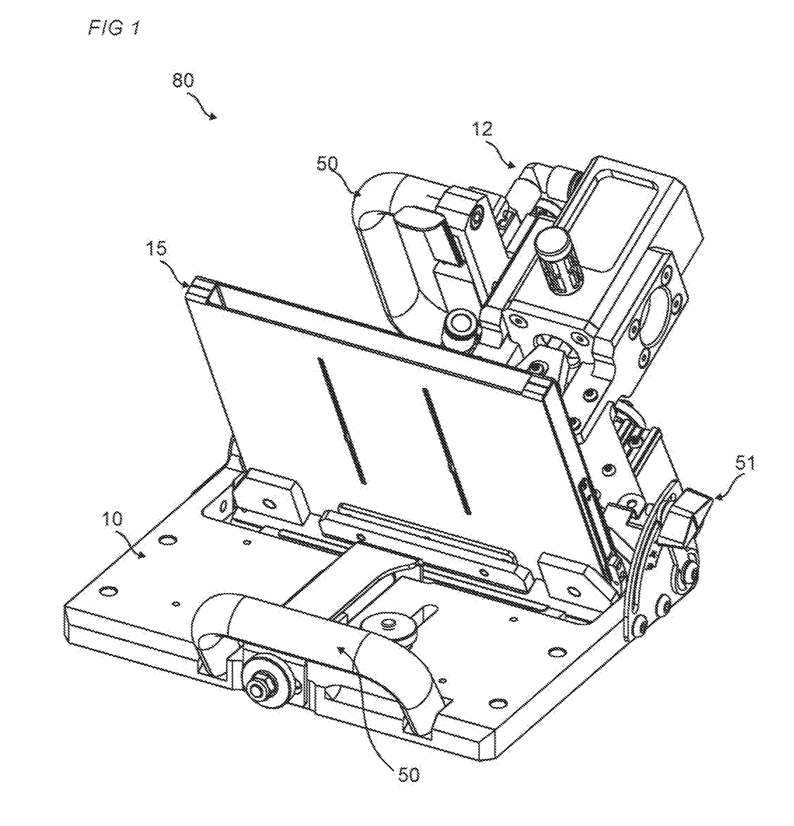

An embodiment of the device is shown in FIG. 1 to FIG. 5. FIG. 1 that may improve an insertion of a tongue in an insertion groove of a panel.

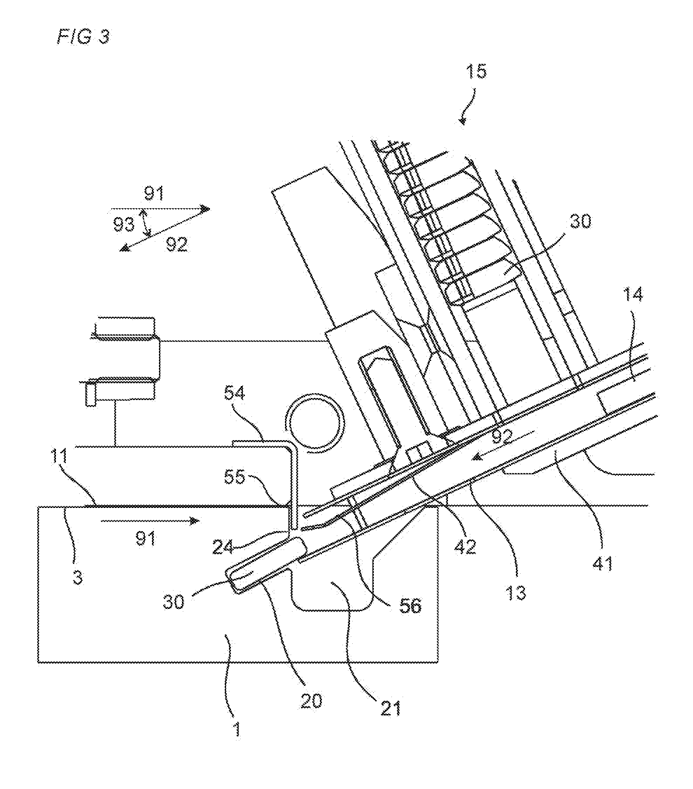

An embodiment of the device 80 is shown in a 3D-view, the device 80 for inserting a tongue 30 into an insertion groove 20 a panel 1, see FIG. 3. The device comprises a first part 10 comprising a supporting surface and the first part is connected to a second part 12. The device may comprise a first adjusting device 51 for setting an angle between the first and the second part. Each of the first and the second part may comprise a handle 50 and the second part may comprise a magazine for two or more of said tongue 30. The device may be configured to be handheld and the handle may comprise a trigger. The device may comprise an attachment device (not shown) and may be configured to be attached to a holding fixture or an assembling table by the attachment device.

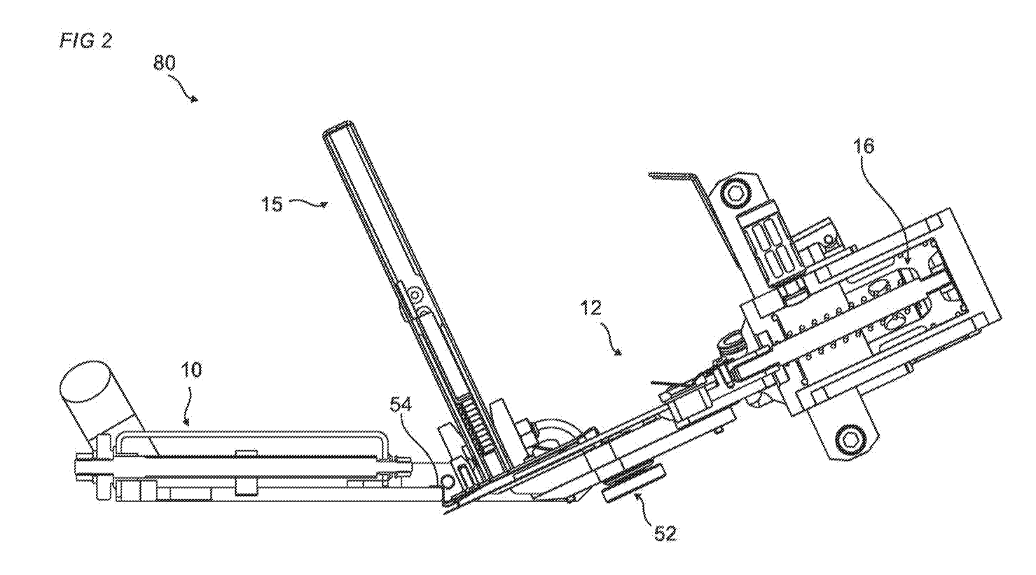

The embodiment shown FIG. 2 in a crosscut in a side view, comprises a power unit 18 for driving a puncher 14 during a punch for the insertion of the tongue 30 in the insertion groove 20. The magazine 15 may extend essentially perpendicular to the second part 12.

FIG. 3 shows an enlargement of some of the parts shown in FIG 2. The first art 12 comprising a supporting surface 11 configured to directly cooperate with an upper surface 3 of a panel 1, such that the supporting surface and the device are positioned relative the upper surface of the panel, and the second part comprise a displaceable puncher 14 and a guiding device 13 which is configured to guide the displaceable puncher 14. The displaceable puncher 14 is configured to displace a tongue 30 into an insertion groove 20 of the panel 1.

The cooperation between the supporting surface and the upper surface of the panel may have the advantage that the device is positioned relative the insertion groove with great precision.

The weight of the device may press the supporting surface to the panel surface or for e.g. an embodiment of the device which is attached to a holding structure the panel may be pressed the supporting surface.

The supporting surface 11 is extending in a first direction 91 and the guiding device 13 is extending in second direction 92. The displaceable puncher 13 may be displaceable in the second direction 92.

The first part 10 preferably comprises a positioning element 54 for positioning the first part relative the insertion groove in the first direction 91. A centre of gravity of the device is preferably adjacent o at the positioning element such that the device is easy to handle and to position in the correct position. This may be an advantage particularly for a handheld embodiment of the device.

A surface 55 of the positioning element may be configured to cooperate with an edge surface 14 of the panel.

A first angle 93, which is between the first direction 91 and the second direction 92, may be in the range of about 10° to about 90°, preferably in the range of about 10° to about 45°, or may be about 25°. The device may comprise a first adjusting device 51, see FIG. 1, for setting the first angle 93.

The second part 12 may comprise a magazine 15 for two or more of said tongue 30. The magazine may be configured for storing a second of said tongue above a first said tongue and the magazine 15 may be extending essentially perpendicular to the second direction 15.

The guiding device 13 may comprise a flexible guiding element 56 at an outer part of the guiding device. The flexible guiding element is configured to guide the tongue 30 into the insertion groove 20.

The insertion groove 20 may be of an elongated shape and may be extend with a length direction along the upper surface of the panel.

The tongue 30 may be of an elongated shape and length direction of the tongue may be parallel with the length direction of the insertion groove 20.

The tongue 30 may be of an elongated shape and a length direction of the tongue may be perpendicular to a displacement direction of the displaceable puncher 14.

The second part 12 may comprise a structural part 41 and a second adjusting 52 device, see FIG. 2. The guiding device 13 may be attached to the structural part 41 and the second adjusting 52 device may be configured for setting a position of the guiding device 13 relative the structural part 41 in the second direction 92.

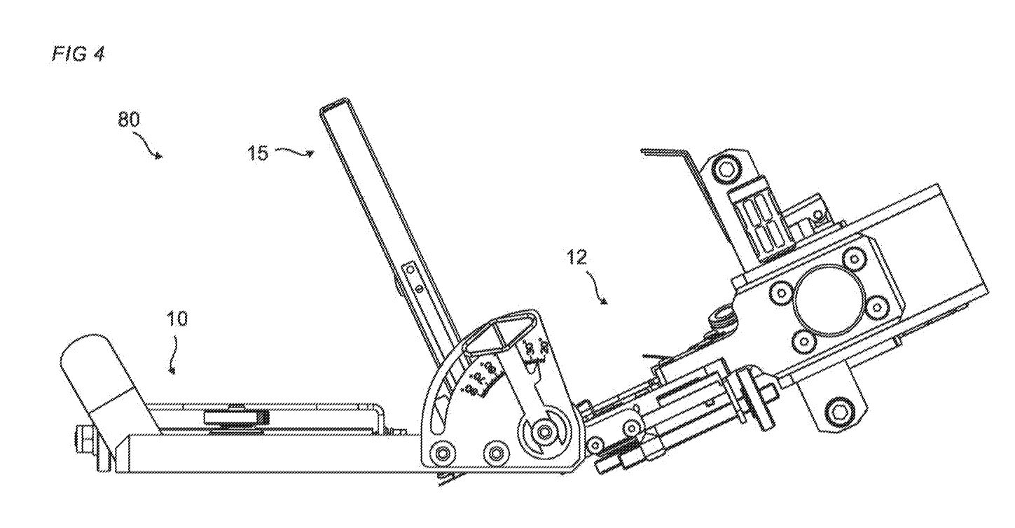

FIG. 4 shows air embodiment of the device 80 in a side view comprising the first part 10 the second part 12 and the magazine 15.

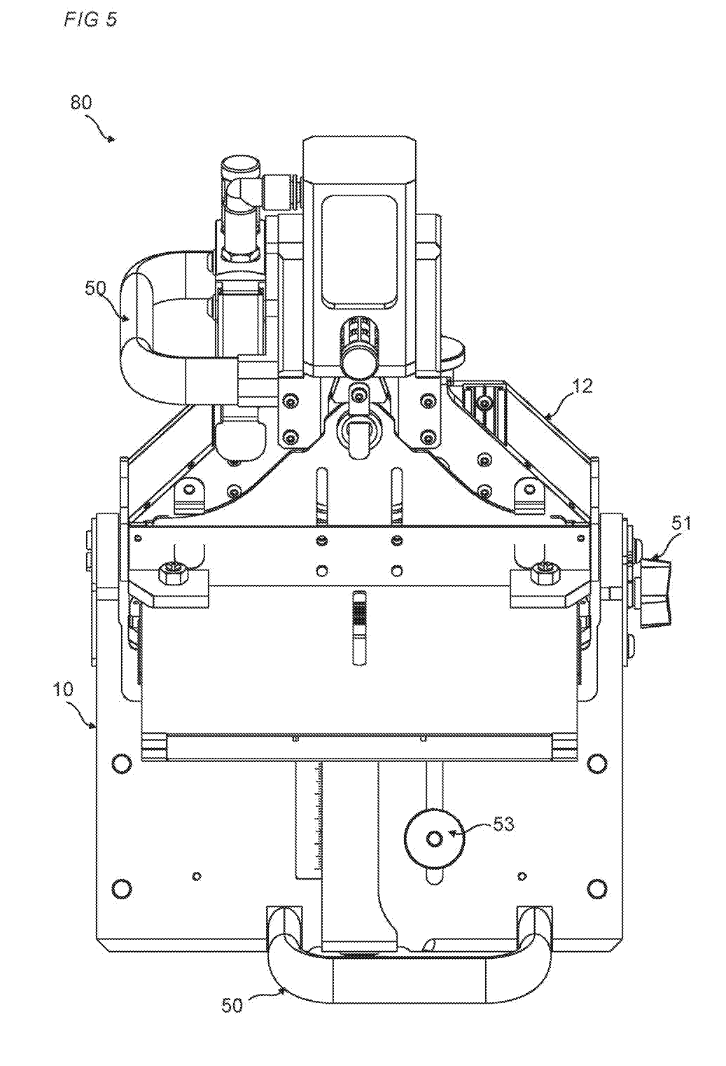

FIG. 5 shows a top view of the embodiment of the device. The fist part 10 of the device may comprise a third adjusting device 53 for setting a position of the positioning element 54 relative the first part 10 in the first direction 91.

An embodiment of the device comprising the first, the second and the third adjustment devices may be an advantage if the device is intended to be used for inserting tongues in insertion grooves and panels of different shapes. However, embodiment which intended to be used for inserting tongues in a more limited variety of shapes may lack one or more of the adjustment devices.

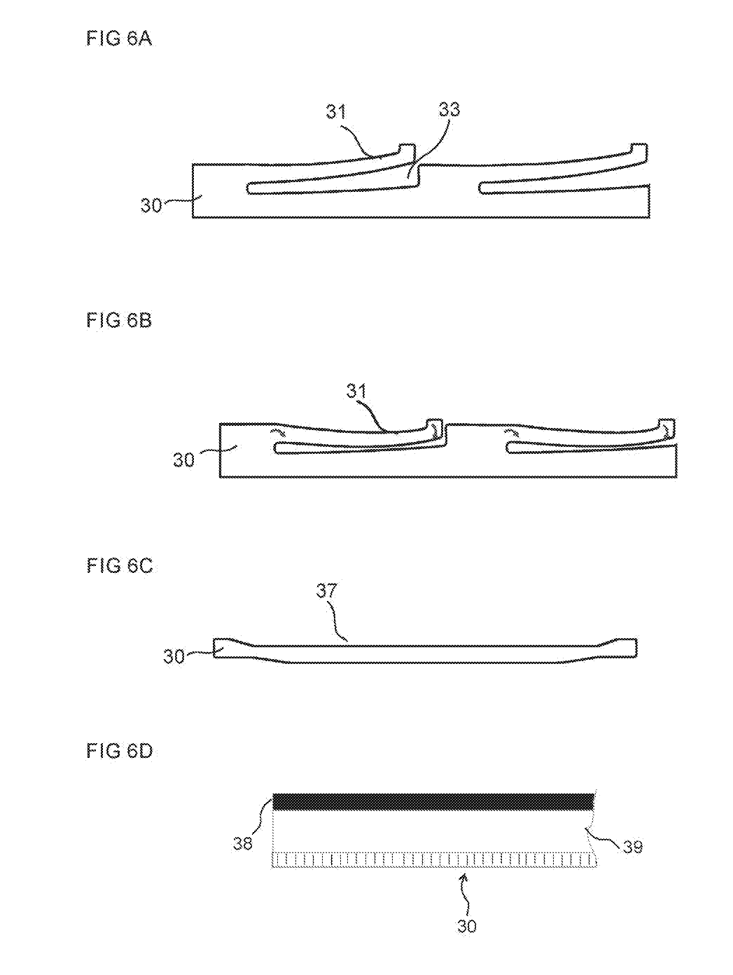

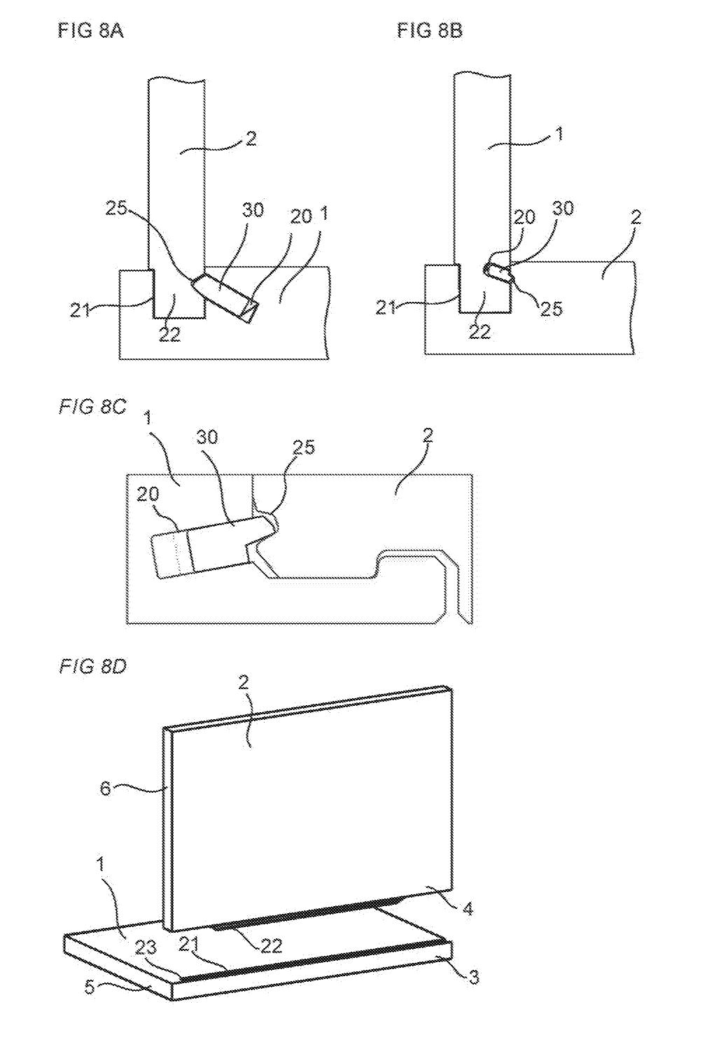

Embodiments of the tongue 30, which may be displaceable in an insertion groove 20 see FIGS. 8A-8D, is shown in FIGS. 6A-6D. A first embodiment of the tongue, which is shown in FIG. 6A-68, comprises bendable protruding parts 31 at a first long edge of the tongue. The first embodiment is shown in a relaxed state in FIG. 6A and in a compressed state in FIG. 6B A second long edge of the tongue is preferably essentially straight. The first embodiment may be inserted into the insertion groove with the bendable protruding parts facing towards a bottom of the insertion groove and the second edge extending beyond an opening of the insertion groove. A second embodiment of the tongue, which is shown in FIG. 6C in a relaxed state, is of an elongated shape and flexible. The second embodiment comprises a recess 37 at a first long edge of the tongue and a second edge which is essentially straight. The recess is decreased in a compressed state of the second embodiment. The second embodiment may be inserted into the insertion groove with the recess 37 facing towards a bottom of the insertion groove and the second edge extending beyond an opening of the insertion groove. A third embodiment of the tongue, which is shown in FIG. 6D, comprises a first part 37, which is flexible and configured to be compressed, and a second part which is rigid. The first, part may be arranged in the insertion groove and the second part may partly extend beyond ab opening of the insertion groove.

The tongue may be or as any of the embodiments of the displaceable tongue disclosed in, e.g., WO2006/043893 and WO20071015689, the entire contents of which are hereby expressly incorporated by reference.

The tongue may be flexible and made of, e.g., a polymer and preferably comprising a reinforcement material, such as a fibre e.g. glasfiber.

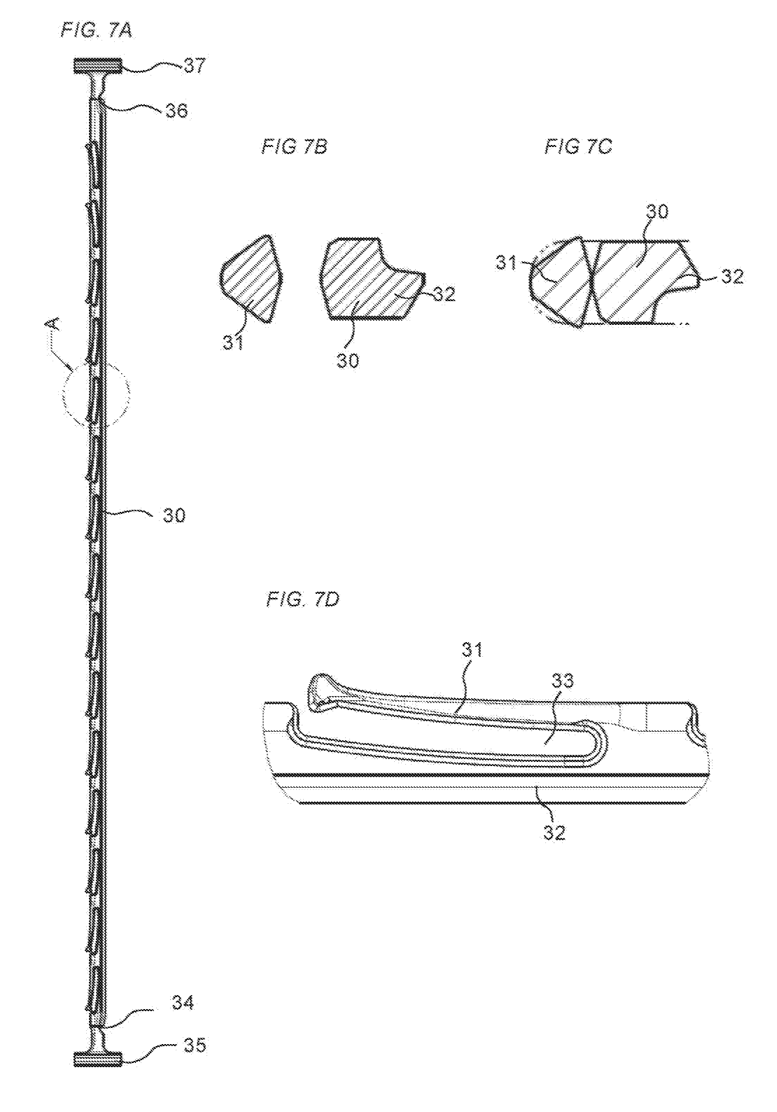

Another embodiment of the tongue 30 is shown in FIGS. 7A-D. The tongue is of an elongated shape and comprises a first short edge 34, an opposite second short edge 36, first long edge and a second long edge 32. FIG. 7D shows an enlargement of the encircled area A indicated in FIG. 7A. The tongue comprises several bendable parts 31 at the first long edge and a groove 33 at each bendable part 31. The tongue comprises a polymer material and is preferably produced by injection moulding. The bendable part 31 is configured to be pushed into the groove 34 in a compressed state of the tongue.

FIG. 7A shows an embodiment of tongue which is connected to several tongues (not shown) in a tongue blank by a first rail 35 at the first short edge 34 and by a second rail 37 at the second short edge 36. The first rail and the second rail is extending in a length direction perpendicular to the tongue. The tongue may be connected to the first rail and/or the second rail, which may be casting gates, by a first and a second casting gate, respectively. The tongues are separated from the first and/or the second rail before a stacking in magazine configured to be attached to the device.

FIG. 7B and FIG. 7C show the tongue 30 in a cross cut view. The tongue is in FIG. 4B in a relaxed state and in FIG. 4C in a compressed state. A distance between an outer part of the bendable part 31 and the second long edge 32 is shorter in the compressed state compared to in the relaxed state.

The tongue is preferably configured to be inserted into an insertion groove of a panel for locking the panel to an adjacent panel.

FIGS. 8A-5D shows embodiments of the panel 1, each comprising an embodiment of the tongue 30 inserted in an embodiment of the insertion groove 20, connected to an adjacent panel 2. The embodiments of the panel shown in FIGS. 8A-8D may be furniture panels. The embodiment of the panel shown in FIG. 8C may also be a floor panel.

FIG. 8A shows the panel 1 arranged perpendicular to an adjacent panel 2 and locked to the adjacent panel in a first direction and in a second direction, which is perpendicular to the first direction. The panel comprising an edge groove 2 at an upper surface of the panel. The edge groove 22 is of a longitudinal shape and is extending along an edge of the panel 1. The edge groove comprising said insertion, groove 20, which is extending along the edge groove, comprising said tongue 30. The adjacent panel comprises an edge tongue 22 which comprises a tongue groove 25 extending along an edge of the adjacent panel. The tongue 30 is configured to cooperate with the tongue groove 25 for locking together the panel 1 with the adjacent panel 2 in the first direction. The edge tongue 22 is configured to cooperate with the edge groove 21 for locking together the panel 1 with the adjacent panel 2 in the second direction.

FIG. 8B shows the panel 1 arranged perpendicular to an adjacent panel 2 and locked to the adjacent panel in a first direction and in a second direction, which is perpendicular to the first direction. The adjacent panel comprising an edge groove 21 at an upper surface of the adjacent panel. The edge groove 22 is of a longitudinal shape and is extending along an edge of the adjacent panel 1. The edge groove comprises a tongue groove 25. The panel comprises an edge tongue 22 which comprises said insertion groove 20 comprising said tongue 30. The insertion groove is extending along the edge tongue. The tongue 30 is configured to cooperate with the tongue groove 25 for locking together the panel 1 with the adjacent panel 2 in the first direction. The edge tongue 22 is configured to cooperate with the edge groove 21 for locking together the panel 1 with the adjacent panel 2 in the second direction.

FIG. 8C shows the panel 1 arranged parallel to an adjacent panel 2 and locked to the adjacent panel in a first direction and in a second direction, which is perpendicular to the first direction. The panel comprising said insertion groove 20 which is extending along an edge of the panel. The edge comprises a strip protruding from the edge and the strip comprises an upwardly protruding locking element. The adjacent panel 2 comprises a tongue groove 25 extending along an adjacent edge of the adjacent panel 2. The adjacent edge comprises a locking groove with an opening facing downwards. The tongue 30 is configured to cooperate with the tongue groove 25 for locking the panel to the adjacent panel in a first direction and the locking element is configured to cooperate with the locking groove for locking the panel to the adjacent panel in the second direction. An embodiment of the said first and second panel comprises the insertion groove 20 at the adjacent edge of the adjacent panel and the tongue groove 25 at the edge of the panel.

FIG 8D shows an embodiment of the panel and the adjacent panel shown in FIG. 8A in a 3D-view, The edge tongue 22 is extending along the edge 4 of the adjacent panel and ends before an adjacent edge 6 of the adjacent panel 2. The edge groove 21 is extending along the edge 3 of the panel 1 and ends at a side wall 23 before an adjacent edge of the 5 of the panel 1.

A core material of embodiments of the panel and the adjacent panel described above may comprises a wood fibre based board, such as a HDF, MDF, plywood, solid wood or particleboard, or a reinforced plastic board or a wood fibre composite board. The core may be provided with a decorative layer.

1. A device for inserting a tongue into an insertion groove in a panel,
wherein the device comprises a first part comprising a supporting surface configured to directly cooperate with an upper surface of a panel, such that the supporting surface is positioned relative the upper surface of the panel,
wherein the device comprises a second part, which is connected to the first part,
wherein the second part comprises a displaceable puncher and a guiding device which is configured to guide the displaceable puncher, and
wherein the displaceable puncher is configured to displace a tongue into an insertion groove of the panel, wherein the supporting surface is extending in a first direction and the guiding device is extending in second direction.

2. The device as claimed in claim 1, wherein the device comprises a handle and is configured to be handheld.

3. The device as claimed in claim 2, wherein the handle comprises a trigger for activating a stroke of the displaceable puncher.

4. The device as claimed in claim 1, wherein the device comprises an attachment device and is configured to be attached to a holding fixture or an assembling table.

5. The device as claimed in claim 1, wherein the displaceable puncher is displaceable in the second direction.

6. The device as claimed in claim 1, wherein a first angle, which is between the first direction and the second direction, is in the range of about 10° to about 90°.

7. The device as claimed in claim 6, wherein the device comprises a first adjusting device for setting the first angle.

8. The device as claimed in claim 1, wherein the second part comprises a structural part, wherein the guiding device is attached to the structural part, wherein the second part comprises a second adjusting device for setting a position of the guiding device relative the structural part in the second direction.

9. The device as claimed in claim 1, wherein the first part comprises a positioning element for positioning the first part relative the insertion groove in the first direction.

10. The device as claimed in claim 9, wherein the first part comprises a third adjusting device for setting a position of the positioning element relative the first part in the first direction.

11. The device as claimed in claim 1, wherein the second part comprises a magazine for two or more of said tongue.

12. The device as claimed in claim 11, wherein the magazine is configured for storing a second of said tongue above a first said tongue, wherein the magazine is extending essentially perpendicular to the second direction.

13. The device as claimed in claim 1, wherein the second part comprises a power unit for driving the puncher during a punch for the insertion of the tongue in the insertion groove.

14. The device as claimed in claim 1, wherein the insertion groove is of an elongated shape and is extending with a length direction along the upper surface of the panel.

15. The device as claimed in claim 14, wherein the tongue is of an elongated shape and a length direction of the tongue is parallel with the length direction of the insertion groove.

16. The device as claimed in claim 1, wherein the tongue is of an elongated shape and a length direction of the tongue is perpendicular to a displacement direction of the displaceable puncher.
